(19) United States
(12) Patent Application Publication
(10) Pub. No.: US 2007/0125687 A1
(43) Pub. Date: Jun. 7, 2007

(54) SCREEN ASSEMBLY FOR A VIBRATORY SEPARATOR

(76) Inventor: Edward A. Kutryk, Calgary (CA)

Correspondence Address: SEAN W. GOODWIN, 222 PARKSIDE PLACE, 602-12 AVENUE S.W., CALGARY, AB, T2R 1J3, CA

(21) Appl. No.: 11/164,698

(22) Filed: Dec. 1, 2005

(51) Int. Cl. B07B 1/49

(52) U.S. Cl. 209/397

(57) ABSTRACT

A pretensioned screen assembly for a vibratory separator includes a perforated plate for supporting screening material, with the perforated plate having downwardly extending tabs. The tabs have a vertical portion that extends along and attaches to a side of a generally rectangular supporting frame. The tabs can also be L-shaped tabs further having a horizontal portion that extends along a bottom of the frame. The tabs are attached at least to frame members that are most susceptible to high frequency vibratory forces. The plate is thereby more securely attached to the frame as compared to conventional perforated plates which are attached only to a top of the frame. Further the tabs structurally reinforce the frame members to which they are attached. Consequently, the screen assembly is more resistant to separation of the screen assembly components caused by vibration-induced flexing.

### FIELD OF THE INVENTION

The invention relates to screens and in particular to a screen assembly for a vibratory separator such as a shale shaker.

### BACKGROUND OF THE INVENTION

Drilling mud is used while drilling oil and natural gas wells on a drilling rig to control subsurface pressures, lubricate the drill bit, stabilize the wellbore, and carry cuttings and other debris to the surface, among other functions. The drilling mud is pumped through a drill string and out of a drill bit, then returned to the surface through the annular space between the drill string and the wellbore. At the surface, cuttings and other solids that are entrained in the mud are typically separated from the mud by a vibrating screen separator called a shale shaker.

Shale shakers include a lower stationary base, called an under flow pan, and an upper vibratable basket that has connected to it a high frequency linear angular motion or rotary vibratory motor. Mounted generally horizontally in the basket is one or more screen assemblies having one or more layers of tensioned screening material. In use, solids-laden mud flows onto one end of the screen deck and solids retained by the screening material are conveyed by vibratory action to the other end where they are discharged. Fluids and small particles pass through the screening material and are collected in a tank system for further processing and reuse in the active system.

Screen assemblies can be distinguished by the way that they provide tensioned screening material. One system is to use hook strips on the basket sides of the screening material in association with tensioning mechanisms on the shale shaker. Alternatively, pretensioned screen assemblies include tensioned screening material attached to a rigid perforated plate, which is in turn attached to a generally rectangular structural frame. The perforated plate supports the screening material and contains a plurality of openings to permit the screened fluid to collect beneath the screening assembly. The frame is used to mount the screen assembly onto corresponding support rails of the basket and the sides of the screening assembly are secured thereto. For example, wedge blocks can be wedged between the top periphery of the screen assembly and wedge angles extending radially inwardly from sides of the screen basket. The sides of the screening assembly are thereby securely sandwiched between the support rails and the wedge blocks.

In one type of construction, the screening material layers are bonded to the perforated plate, which is in turn bonded to the top surface of the frame to form an integral screen assembly. The screen assembly is subject to tremendous stresses caused by the vibratory machinery. In particular, upward and downward stroking motion of the vibratory motor causes the screen assembly to oscillate between the secured sides. In other words, the unsecured area of the screening assembly can vibrate at greater amplitude than the sides, thereby causing out of plane flexing. Such flexing eventually results in failure of the bonding of the perforated plate to the frame and the screen material, as well as a loss of structural integrity of the screen material, the perforated panel and the frame. In general, greater flexing occurs with greater g-forces. Further, as drilling mud flows over the screens, the upward stroking motion drives the mud into the screen with the impinged mud creating additional reactive force against the downward stroking motion.

Flexing of the screening assembly is a major cause of early deterioration of pretensioned screens, such as separation of components of the screening assembly, contributing greatly to increased operational costs of the shale shaker due to the man-hours required to replace the screen, loss of rig operating time, and cost of replacement screens. To increase the rigidity of the screening assembly for withstanding flexing forces, pretensioned screens are typically made of thick structural tubing and thick perforated plates. This construction, however, results in high manufacturing costs and makes the screening assembly heavy and difficult to handle. While texturing of the bonding surface of perforated plate has been used to increase the bonding strength between the perforated plate and the frame, this approach has not proven to be totally adequate.

There is, therefore, a need in the art for an improved screen for a vibratory separator.

### SUMMARY OF THE INVENTION

A screen assembly for a vibratory separator is provided whereby a perforated plate for supporting screening material is more securely attached to a frame as compared to conventional screen assemblies. Consequently, the screen assembly is more resistant to damage caused by out of plane flexing of the screen assembly when subjected to high frequency vibratory forces in the vibratory separator.

In a broad aspect of the invention, the perforated plate of the screening assembly is attached not only to a top of the frame, as with conventional screening assemblies, but also to sides of the frame, and in particular at least to sides of frame members that are most susceptible to flexing. The attachment of the perforated plate to sides of the frame thereby provides for more secure attachment, and also structurally reinforces the frame members to which the perforated plate is attached.

Accordingly, in an embodiment of the invention there is provided a screening assembly comprising a generally rectangular outer frame section, a perforated plate attached to the frame, and one or more layers of screening material supported on and attached to the perforated plate. The outer frame section includes a pair of spaced apart longitudinal side members and a pair of spaced apart transverse end members, where the longitudinal side members are to be securely mounted on a vibratable basket of a vibratory separator. The perforated plate includes a substantially planar portion for supporting the screening material, with the planar portion having a plurality of openings formed therein. The perforated plate further includes a pair of opposing tabs extending downwardly from the planar portion, with the tabs having a vertical portion. The planar portion of the perforated plate is supported on and attached to a top of the frame with the vertical portion of the tabs extending along and attached to a side of the transverse end members.

The tabs can be further configured to be L-shaped tabs which additionally extend along a bottom of the transverse end members.

Additional aspects relating to the construction of the frame are also disclosed.

### BRIEF DESCRIPTION OF THE DRAWINGS

In drawings which are intended to illustrate embodiments of the invention and which are not intended to limit the scope of the invention:

FIG. 1 is a perspective view of one embodiment of a screen assembly according to the present invention, with part of the screening material removed for viewing the perforated plate and the frame;

FIG. 2 is a cross-sectional side view taken along lines ll-ll of FIG. 1 and with the cross members removed;

FIG. 3 is an exploded view of FIG. 1;

FIG. 4 is a cross-sectional side view of another embodiment of a screen assembly according to the present invention;

FIG. 5 is a partial perspective and exploded view of the frame and perforated plate of FIG. 4;

FIGS. 6A is a top view of an outer frame section of the screen assembly of FIG. 1;

FIG. 6B is a top view of the hollow structural tubing used to form the outer frame section of FIG. 6A;

FIG. 6C is a close-up view of a notched area of FIG. 6B;

FIG. 6D is a sectional view taken along lines VI-VI of FIG. 6A;

FIG. 7 is an exploded partial perspective view of intersecting cross members of the frame of the screen assembly of FIG. 1; and

FIG. 8 is a cross-sectional side view of yet another embodiment of a screen assembly of the present invention.

### DESCRIPTION OF THE PREFERRED EMBODIMENT

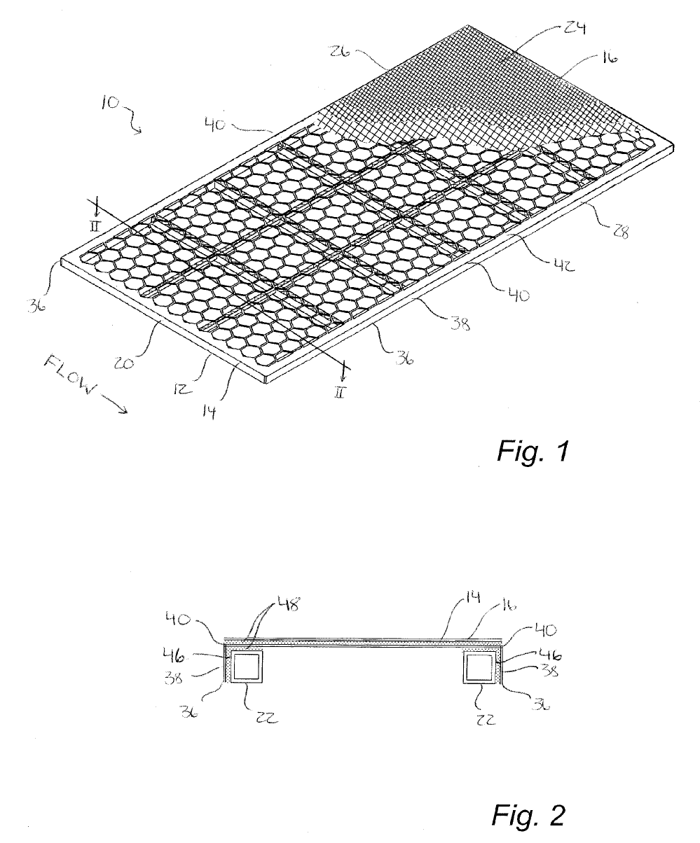

With reference to FIGS. 1-3, an embodiment of a screen assembly 10 for a vibratory separator generally comprises a frame 12, a perforated plate 14 and one or more layers of screening material 16. The screening material 16 is supported on and attached to the perforated plate 14, with the perforated plate 14 in turn being supported on and attached to the frame 12. As described below, the perforated plate 14 includes features that provide for more secure attachment to the frame 12 as compared to conventional perforated plates, thereby enhancing the structural integrity of the screen assembly 10 against vibratory forces.

In further detail, the frame 12 comprises a generally rectangular outer frame section 18 having a pair of spaced apart longitudinal side members 20 and a pair of spaced apart transverse end members 22. In use, the screening assembly 10 is mounted horizontally in a vibratable basket of a vibratory separator (not shown), with the longitudinal side members 20 being clamped or otherwise secured to the basket. Linear angular or rotary vibratory forces are applied to the basket, and hence the screening assembly 10, to cause material on a top 24 of the screening material 16 to move generally longitudinally therealong from one end 26 of the screening assembly 10 to another end 28.

As with conventional perforated plates, the perforated plate 14 comprises a planar portion 32 for supporting the screening material 16 thereupon, with the planar portion 32 having a plurality of holes or perforations 34 punched or otherwise formed therein. The perforations 34 can be of any suitable shape and size to permit sufficient flow-through of screened fluid, while maintaining structural integrity of the perforated plate 14, as would be appreciated by one skilled in the art. In addition, the perforated plate 14 includes a pair of opposing tabs 36 having a vertical portion 38 extending downwardly from transverse edges 40 of the planar portion 32. The tabs 36 may be formed, for example, by downwardly bending a non-perforated periphery 42 of the planar portion 32.

The perforated plate 14 is fit over the frame 12 with the planar portion 32 being supported by an adjacent top 44 of the frame 12, and the vertical portion 38 of the tabs 36 adjacent outer sides 46 of the transverse end members 22 of the frame 12. The perforated plate 14 is attached with bonding material 48 to the adjacent surfaces of the frame 12 and the screening material 16 is in turn bonded with bonding material 48 to the perforated plate 14, thereby forming an integral screen assembly 10. As compared with conventional perforated plates, which are bonded or otherwise attached to only to the top surface 44 of the frame 12, additional attachment of the perforated plate 14 to the outer sides 46 of the transverse end members 22 by the tabs 36 provides for more secure attachment of the perforated plate 14 to the frame 12. Consequently, the perforated plate 14 is more resistant to vibratory detachment from frame 12 upon flexing of the screening assembly 10 in response to upward and downward forces imposed by the vibratory machinery. Further, the tabs 36 of the perforated plate 14 structurally reinforce or stiffen the transverse end members 22 of the frame 12, thereby reducing the risk of bond failure between the frame 12 and the perforated plate 14, as well as between the perforated plate 14 and the screening material 16. Notably, the structural and functional advantages provided by the tabs 36 do not significantly increase the weight of the screening assembly 10.

While the tabs 36 are preferably each a single tab 36 extending along the entire transverse length of the perforated plate 14, the tabs can also extend partially along the transverse length of the perforated plate 14, and can also be a plurality of spaced apart tabs.

Tabs 36 extending along the longitudinal side members 20 can also be provided, although this is generally not necessary as the sides of the screen assembly 10 are typically held in position by wedge blocks.

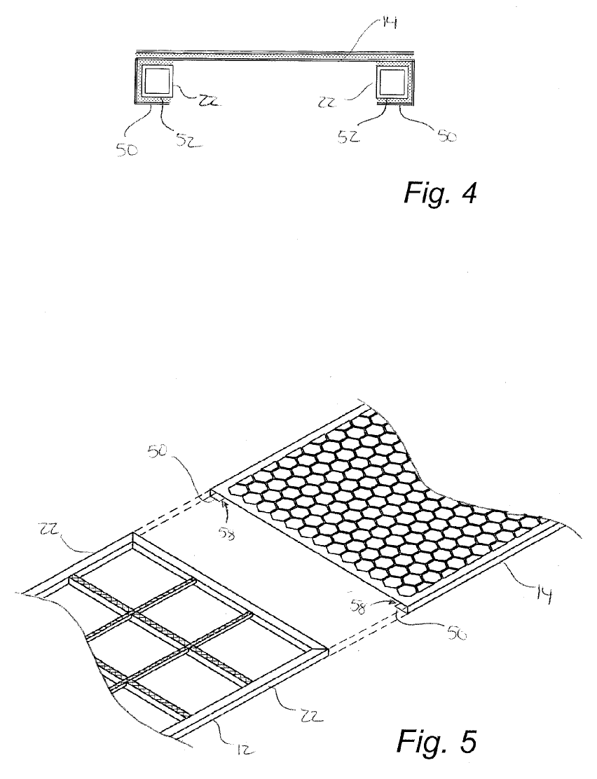

With reference to FIGS. 4 and 5, to further improve the security of the attachment of the perforated plate 14 to the frame 12, the tabs 36 can be L-shaped tabs 36 further having an inwardly directed horizontal portion 50 that extends along a bottom 52 of the transverse end members 22. The horizontal portion 50 thereby vertically clamps the perforated plate 14 onto the transverse end members 22 of the frame 12 and further structurally reinforces the transverse end members 22. While it is not necessary to attach the horizontal portion 50 to the bottom 52 of the transverse end members 22, the overall process of bonding the perforated plate 14 to the frame consequently results in bonding of the horizontal portion 50, as described in detail below.

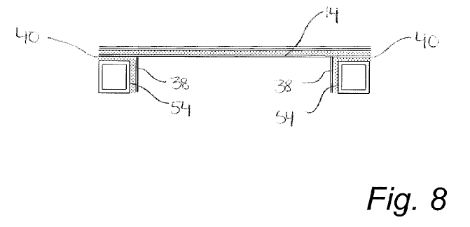

With further reference to FIG. 8, while the perforated plate 14 has thus far been described as having the tabs 36 positioned to extend from the transverse edges 40 of the perforated plate 14, the tabs 36 may be also be inwardly offset from the transverse edges 40 to attach to the vertical portion 38 to an inner side 54 of the transverse end members 22. In this case, the tabs 36 can be formed by welding or otherwise securely attaching the tabs underneath the perforated plate 14.

The components of the screen assembly 10 can be of any suitable fabrication and construction, as would be apparent to one skilled in the art. For example, the frame 12 and the perforated plate 14 can be made of rigid yet malleable material, such as mild steel. The screening material 16 can be made of stainless steel and can also include a plurality of layers of screening material 16, as particularly seen in FIGS. 1-3. Such layers typically progress in mesh size whereby a finer-meshed top layer 16a is supported by more coarsely-meshed lower layers 16b, 16c. The top layer 16a thereby acts as a sizing screen while the lower layers 16b, 16c act as structural layers to extend the life of the top layer 16a. To reduce wear, the lower layers 16b, 16c can be calendared, i.e. flattened where the wires of the screening material 16 intersect.

Preferably, the bonding material 48 is an epoxy thermosetting resin, which can be heated to reversibly transition from a solid state to a flowable fluid state for coating the surfaces of the components of the screen assembly 10. Suitable epoxy includes, for example 10-7010 Corvel® Gray (Rohm and Haas, Philadelphia, Pa.) and Nap-Guard® (DuPont, Mississauga, Ontario, Canada). As an example of an assembly process, each of the frame 12 and the perforated plate 14 can be separately coated with epoxy powder by pre-heating each component in an oven to a suitable temperature and suspending the heated component into a fluidized epoxy powder bed as necessary to develop a coating thereon. Upon return to ambient temperature, the fluid coating re-solidifies and firmly adheres to the surfaces of the components. The epoxy-coated perforated plate 14 is fit over the frame 12 and screening material 16 is placed over the perforated plate 14. The entire assembly 10 is then subjected to a heat press at a suitable temperature to firmly bond the surfaces together to form an integral screen assembly 10. To provide a better surface texture for bonding, the surfaces can be abrasive grit blasted prior to epoxy powder coating.

Where L-shaped tabs 36 are used and with particular reference to FIG. 5, prior to coating and bonding with epoxy, it may be desired to first fit the perforated plate 14 over the frame 12 by inserting a longitudinal side member 20 into channels 58 defined by the L-shaped tabs 36 and further sliding the frame 12 into the channels 58 to form a perforated plate-frame unit. The fitted perforated plate 14 can then be attached to the frame 12 by coating the perforated plate-frame unit with epoxy thermosetting resin, such as described above. Preferably, the epoxy has sufficient flow characteristics to enter between tightly adjacent surfaces, such as 10-7010 Corvel® Gray.

Although it is particularly contemplated to use bonding material 48 for attaching the screen assembly 10 components to form an integral unit, other attachment means can be used alternatively or in addition to the bonding material 48, as would be appreciated by one skilled in the art. Other attachment means can include, for example, tack welding, spot welding, screws, rivets, etc. As an example, where L-shaped tabs 36 are used, it may be desired to spot weld the fitted perforated plate 14 to the frame 12 prior bonding, where in the bonding process the epoxy or other bonding material may enter spaces between the tabs 36 and the frame 12 to effect bonding.

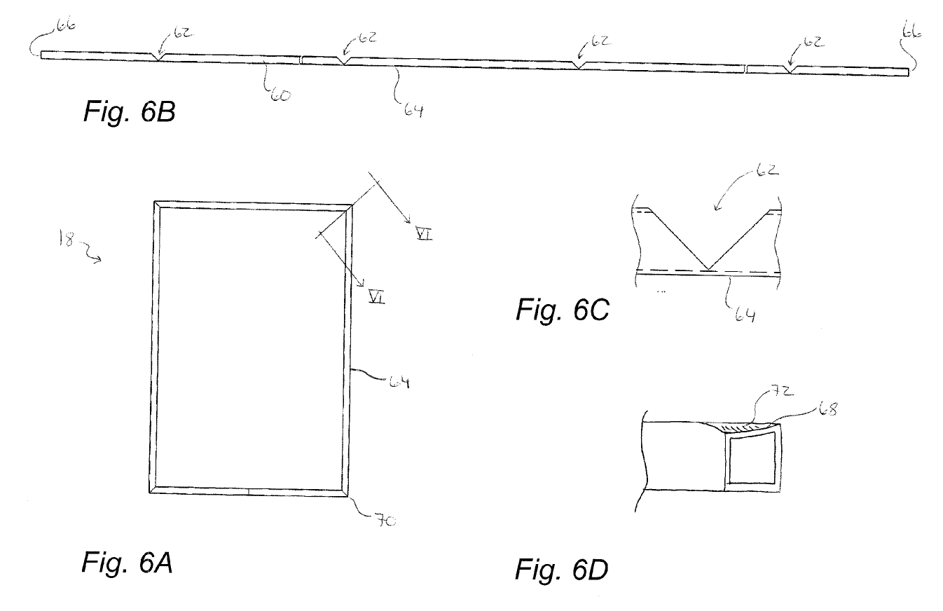

With reference to FIGS. 6A-D, the outer frame section 18 can be constructed of single piece of hollow structural tubing 60 having four spaced-apart corner notches 62, with each notch 62 forming an angle of about ninety degrees extending from an outer wall 64 of the tubing 60. The outer frame section 18 is completed by inwardly bending the tubing 60 around the notches 62 to form a generally rectangular shape and securing the ends 66 together by welding. The notches 62 are preferably formed by punch-cutting such that a top edge 68 of each notch 62 is downwardly deformed, as shown in FIG. 6D. Consequently, the corners 70 of the completed outer frame section 18 advantageously form a top pocket 72 for containing bonding material 48 used to bond the perforated plate 14 to the frame 12, thereby making a more secure bonding connection. In this case, welding on the top pocket 72 should be avoided as welding material may fill the top pocket 72 that would otherwise contain bonding material 48. Further, welding material on any top surface 44 of the frame 12 would potentially interfere with the fitting of the perforated panel 14 on the frame 12 if excess welding material is not removed.

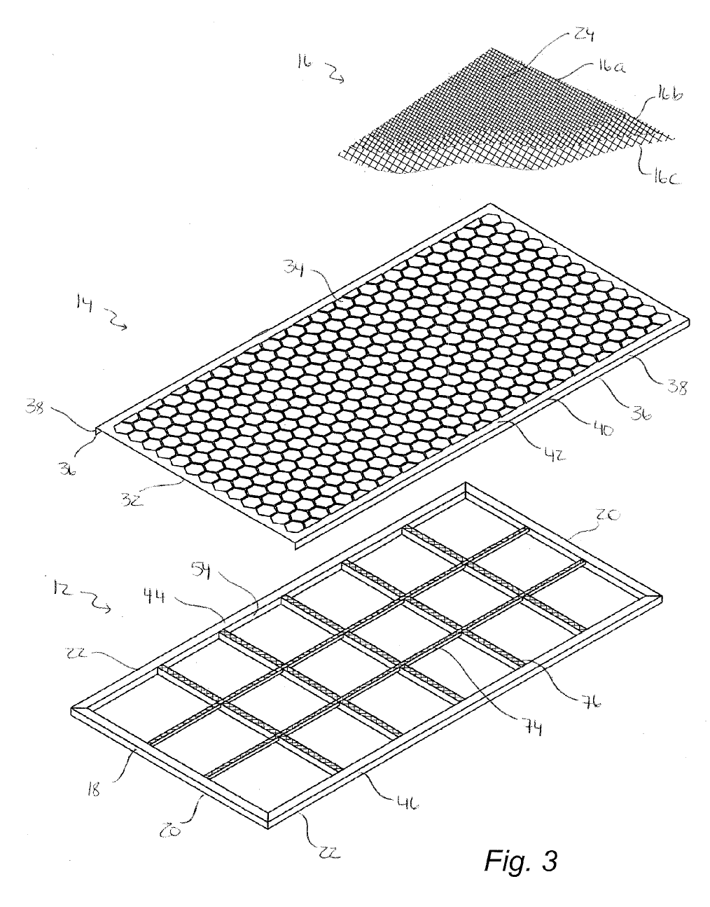

With particular reference to FIG. 3, the frame can also include at least one transverse or longitudinal cross member 74, 76 positioned within the outer frame section 18. The cross member or members 74, 76 thus provide additional structural rigidity to the frame 12 and further support for the perforated plate 14. The cross members 74, 76 can be fabricated from hollow structural tubing, with the cross members 74, 76 being secured such as by welding to the outer frame section 10 or to an oppositely oriented cross member 74, 76.

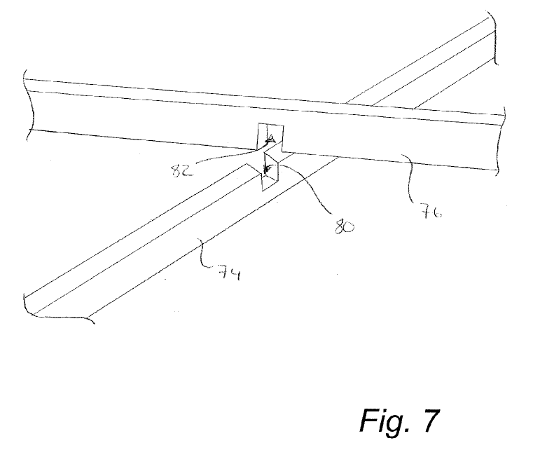

With further reference to FIG. 7, where both transverse cross members 74 and longitudinal cross members 76 are used, the cross members 74, 76 can be interlocked by complementary upward- and downward-facing notches 80, 82 formed such as by punch-cutting.

Other suitable forms of the frame are also contemplated, as would be apparent to one skilled in the art. For example, rather than having a generally rectangular outer frame, the frame can comprise a pair of spaced apart opposing longitudinal sides that are connected by at least one transverse cross-bar to form an H- or a ladder-type arrangement.

Although preferred embodiments of the invention have been described in some detail herein above, those skilled in the art will recognize that various substitutions and modifications of the invention may be made without departing from the scope of the invention as defined by the claims as defined herein.

What is claimed is:

1. A screen assembly for a vibratory separator comprising:
a generally rectangular outer frame section having a pair of spaced apart longitudinal side members and a pair of spaced apart transverse end members;
a perforated plate having a substantially planar portion with a plurality of openings formed therein, the planar portion being supported on a top of the outer frame section and attached thereto, the perforated plate further having a pair of opposing tabs extending downwardly from the planar portion, the tabs having a vertical portion extending along a side of the transverse end members of the outer frame section and attached thereto; and one or more layers of screening material supported on a top of the planar portion of the perforated plate and attached thereto.

2. The screen assembly of claim 1 wherein the tabs are L-shaped tabs further having a horizontal portion extending along a bottom of the transverse end members of the frame.

3. The screen assembly of claim 1 wherein the attachment is by a bonding material.

4. The screen assembly of claim 3 wherein the bonding material is epoxy thermosetting resin.

5. The screen assembly claim 1 wherein the outer frame section is made of a linear piece of hollow structural tubing having four V-shaped corner notches formed therein, the V-shaped notches forming an angle of about 90 degrees extending from an outer wall of the tubing, the outer frame section being formed by inwardly bending the linear tubing around the V-shaped corner notches.

6. The screen assembly of claim 5 wherein the notches are punch cut so as to form a depression in a top of each corner of the formed frame.

7. The screen assembly of claim 1, the frame further comprising one or more cross members positioned within the outer frame section and attached thereto.

8. The screen assembly of claim 7 wherein the one or more cross members includes:
a transverse cross member; or
a longitudinal cross member; or
a combination of a transverse cross member and a longitudinal cross member.

9. The screen assembly of claim 8 wherein the transverse and longitudinal cross members are interconnected therebetween.

10. The screen assembly of claim 9 wherein the transverse and longitudinal cross members are interconnected by complementary notches formed therein.

11. A screen assembly for a vibratory separator comprising:
a frame, the frame having a generally rectangular outer frame section having a pair of spaced apart longitudinal side members and a pair of spaced apart transverse end members, the frame further having a one or more cross members positioned within the outer frame section and attached thereto;
a perforated plate having a substantially planar portion with a plurality of openings formed therein, the planar portion being supported on a top of the frame, the perforated plate further having a pair of opposing tabs extending downwardly from the planar portion, the tabs having a vertical portion extending along a side of the transverse end members, the perforated plate being attached to the frame by bonding with epoxy thermosetting resin, and
one or more layers of screening material supported on a top of the planar portion of the perforated plate and attached thereto by bonding with epoxy thermosetting resin.

12. The screen assembly of claim 11 wherein
the tabs are L-shaped tabs further having a horizontal portion extending along a bottom of the transverse end members, and wherein
the perforated plate is further attached to the frame by spot welding.

13. A perforated plate for supporting screening material in a screen assembly, the screen assembly for use in a vibratory separator, the screen assembly comprising a generally rectangular outer frame section having a pair of spaced apart longitudinal side members and a pair of spaced apart transverse end members; the perforated plate comprising:
a substantially planar portion with a plurality of openings formed therein, the planar portion for being supported on a top of the frame; and
a pair of opposing tabs extending downwardly from the planar portion, the tabs having a vertical portion for extending along a side of the transverse end members when the planar portion is supported on the top of frame.

14. The perforated plate of claim 13 wherein the tabs are L-shaped tabs further having a horizontal portion for extending along a bottom of the transverse end members when the planar portion is supported on the top of frame.

15. A method of assembling the screen assembly of claim 2 comprising:
fitting the perforated plate over the frame by inserting a longitudinal side into channels defined by the L-shaped tabs and further sliding the frame into the channels to form a perforated plate-frame unit;
attaching the fitted perforated plate to the frame by bonding with epoxy thermosetting resin by coating the perforated plate-frame unit with the resin and subjecting the perforated plate-frame unit to a temperature that permits bonding;
placing the screening material over the perforated plate to form a screen assembly; and
attaching the screening material to the perforated plate by subjecting the screen assembly to a heat press at a temperature that permits bonding.

16. The method of claim 15 further comprising:
attaching the fitted perforated plate to the frame by spot welding prior to the attaching of the fitted perforated plate to the frame with epoxy thermosetting resin.
